(19) United States
(12) Patent Application Publication
(10) Pub. No.: US 2024/0059282 A1
(43) Pub. Date: Feb. 22, 2024

(54) VEHICULAR DRIVING ASSIST SYSTEM WITH CROSS TRAFFIC DETECTION USING CAMERAS AND RADARS

(71) Applicant: Magna Electronics Inc., Auburn Hills, MI (US)

(72) Inventors: Venkata Satya Siva Prasad Challa, Troy, MI (US); Kirti Hiranand Balani, Maharashtra (IN)

(21) Appl. No.: 18/451,192

(22) Filed: Aug. 17, 2023

Related U.S. Application Data
(60) Provisional application No. 63/371,767, filed on Aug. 18, 2022.

(51) Int. Cl. B60W 30/09; B60W 30/095; B60W 30/18; B60W 50/16; B60W 60/00; B60W 10/18; G06V 20/56

(52) U.S. Cl. CPC B60W 30/09; B60W 30/0956; B60W 30/18154; B60W 50/16; B60W 60/0053; B60W 10/18; G06V 20/588; B60W 2420/42; B60W 2420/52; B60W 2552/53; B60W 2554/4041; B60W 2554/4045; B60W 2554/406; B60W 2554/80; B60W 2556/35

(57) ABSTRACT

A vehicular driving assist system includes a camera and a radar sensor disposed at a vehicle. The system, via processing at the ECU of captured image data and captured sensor data, detects an object and determines that the detected object is traveling along a lane that intersects with a lane the vehicle is traveling along. The system, responsive to processing of captured image data and captured sensor data and responsive to determining that the detected object is traveling along the lane that intersects with the lane the vehicle is traveling along, determines a time to collision (TTC) between the vehicle and the detected object at the intersection. The system, responsive to determining that the TTC is below a threshold amount of time, generates a braking command to slow the vehicle prior to reaching the intersection.

### CROSS REFERENCE TO RELATED APPLICATION

The present application claims the filing benefits of U.S. provisional application Ser. No. 63/371,767, filed Aug. 18, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a camera disposed at a vehicle equipped with the vehicular driving assist system. The camera views at least forward of the vehicle and operable to capture image data. The system includes a radar sensor disposed at the vehicle. The radar sensor senses at least forward of the vehicle and is operable to capture sensor data. A field of sensing of the radar sensor at least partially overlaps a field of view of the camera. The system includes an electronic control unit (ECU) that includes electronic circuitry and associated software. Image data captured by the camera and sensor data captured by the radar sensor are transferred to and are processed at the ECU. The vehicular driving assist system, via processing at the ECU of image data captured by the camera and transferred to the ECU, determines lane markers of a road along which the vehicle is traveling. With the vehicle approaching an intersection, the vehicular driving assist system, based at least in part on processing at the ECU of (i) image data captured by the camera and transferred to the ECU and (ii) sensor data captured by the radar sensor and transferred to the ECU, determines that an object is traveling along a traffic lane that intersects with a traffic lane the vehicle is traveling along. The vehicular driving assist system, responsive to determining that the object is traveling along the traffic lane that intersects with the traffic lane the vehicle is traveling along, determines a time to collision (TTC) between the vehicle and the object at the intersection. The vehicular driving assist system, responsive at least in part to determining the TTC between the vehicle and the object at the intersection is below a threshold amount of time, generates a braking command to slow the vehicle prior to the vehicle reaching the intersection.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a driving assist system that incorporates cameras;

FIG. 2 is a schematic view of a vehicle approaching an intersection with multiple cross-traffic threats; and

FIG. 3 is a block diagram of the driving assist system of FIG. 1.

### DESCRIPTION OF THE PREFERRED EMBODIMENTS

A vehicle sensor system and/or driver or driving assist system and/or alert system operates to capture image data exterior of the vehicle and may process the captured image data to display images and to detect objects at or near the vehicle and in the predicted path of the vehicle, such as to assist a driver of the vehicle in maneuvering the vehicle. The driving assist system includes a processor or processing system that is operable to receive sensor data (e.g., image data, radar data, etc.) from one or more sensors (e.g., cameras, radar sensors, lidar, etc.) and detect the presence of one or more objects exterior of the vehicle.

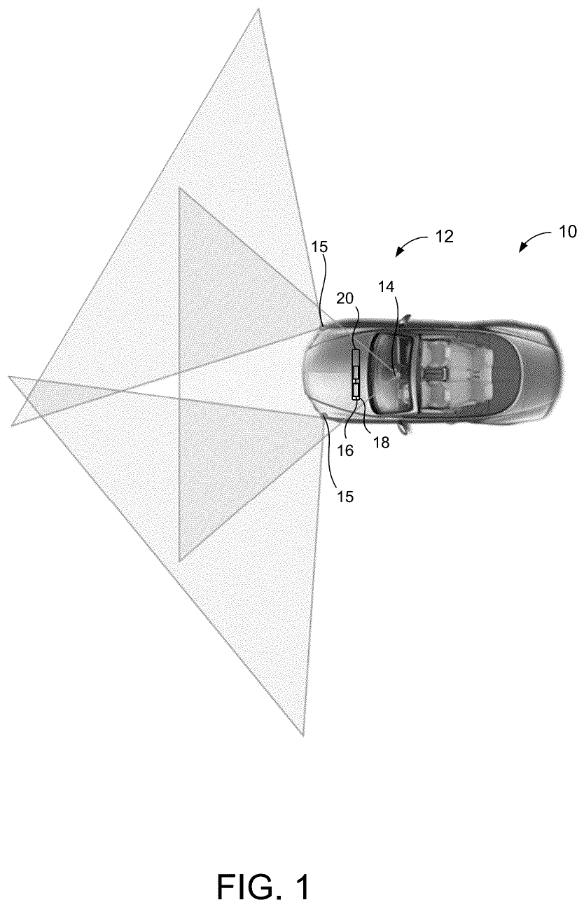

Referring now to the drawings and the illustrative embodiments depicted therein, a vehicle 10 includes an driving assist system 12 that includes at least one exterior viewing imaging sensor or camera, such as a forward viewing imaging sensor or camera 14 (e.g., such as a camera disposed at the windshield of the vehicle and viewing through the windshield and forward of the vehicle). The driving assist system may include multiple exterior viewing imaging sensors or cameras, such as a forward viewing camera at the front of the vehicle, a rearward viewing camera at a rear of the vehicle, and/or a sideward/rearward viewing camera at respective sides of the vehicle, which captures images exterior of the vehicle, with the camera having a lens for focusing images at or onto an imaging array or imaging plane or imager of the camera (FIG. 1). Image data captured by the camera(s) may be used for a machine vision system (such as for traffic sign recognition, headlamp control, pedestrian detection, collision avoidance, lane marker detection and/or the like). Optionally, the system includes one or more radar sensors 15 (e.g., corner radar sensors disposed at a bumper of the vehicle). The driving assist system 12 includes a control or electronic control unit (ECU) 18 having electronic circuitry and associated software, with the electronic circuitry including a data processor or image processor that is operable to process sensor data captured by the camera or cameras or radar sensors, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Environmental sensing forms an integral part of Advanced Driver Assistance Systems (ADAS) deployed in many vehicles today. Multiple environmental sensors such as cameras (e.g., forward-looking cameras such as a windshield-mounted camera that views forward of the vehicle through the windshield) and/or radar sensors are often employed to improve the accuracy and latency of information transfer. A fusion system combines information from these sensors (e.g., combines camera image data and radar sensor data) to increase the accuracy and/or reliability of each sensor and may provide or generate significant information about an environment in front of an equipped vehicle (e.g., object and lane information). Object information may be used for longitudinal control of vehicles (e.g., acceleration and braking control) in many systems. Longitudinal control is frequently used with safety features such as autonomous emergency braking (AEB) as well as comfort features like adaptive cruise control (ACC). Implementations herein generate sensor fusion object data, manage sudden missing objects, maintain the data, and/or predict an object dataset. Thus, implementations herein improve the safety of the driver and other occupants of the vehicle by preventing or minimizing cross-path collisions with vehicles moving on a cross path towards the equipped vehicle.

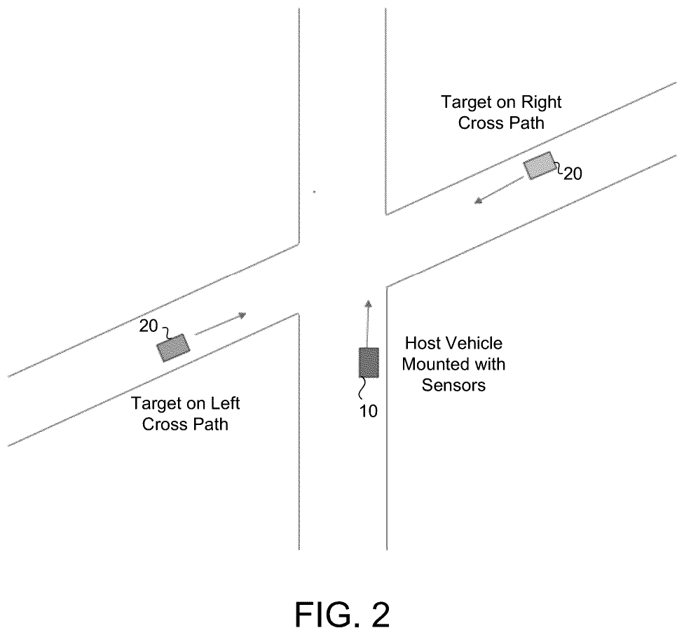

A driver or driving assist system may assist drivers or may assist autonomous control of a vehicle by braking or slowing the vehicle automatically as soon as threats are detected on a cross path with the current path or trajectory of the equipped vehicle. As used herein, the term “threat” indicates a target or object, such as a pedestrian or target vehicle or other object (e.g., a car, a motorcycle, a truck, a bicycle, etc.) which, if the target vehicle continues with the same speed/trajectory on the cross path, has a significant chance of collision with the equipped vehicle. As used herein, the term “host vehicle” or “equipped vehicle” refers to a vehicle mounted with multiple sensors (e.g., radar sensors, lidar sensors, cameras, etc.) and associated software to process the sensor data to detect cross-traffic threats (i.e., equipped with the vehicular driving assist system disclosed herein). A cross path is defined as when a predicted trajectory of a target object or vehicle intersects or crosses with a predicted trajectory of the equipped vehicle (e.g., at an intersection). In an example cross-traffic situation shown in FIG. 2, target vehicles 20 (potential threats for the equipped vehicle 10) approach the path or trajectory of the equipped vehicle 10 from both the left and right cross paths as the equipped vehicle 10 approaches an intersection. In this example, there is a likelihood of a collision between the equipped vehicle 10 and one or both target vehicles 20 as the equipped vehicle 10 approaches and enters the intersection of the two roads.

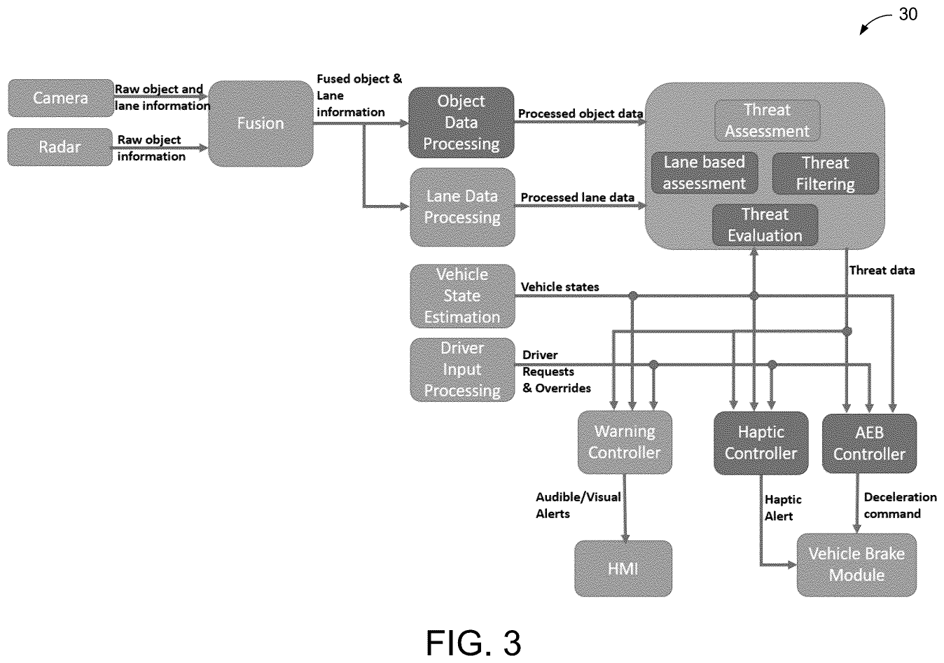

FIG. 3 includes a block diagram 30 that includes exemplary elements of the driving assist system. The system may include one or more cameras (e.g., a front camera module (FCM) or the like). For example, the camera(s) includes hardware and/or software for transmitting raw image data captured by the camera and/or information for multiple objects captured within the field of view of the camera (e.g., object positions, relative velocities, etc.) and lane information (e.g., lane coefficients, marker quality, road junction information, etc.). The system may additionally or alternatively include one or more radar sensors. The hardware and/or software of the radar sensor(s) may transmit raw data for multiple objects detected within the field of sensing of the sensor (e.g., object positions, relative velocities, etc.).

The system may include a fusion module. The fusion module uses a fusion algorithm to fuse information (e.g., from a camera and a radar sensor) to generate more accurate representation of the object data than either sensor produces individually. The fused information may be used by any downstream components. For example, the fusion module implements a Kalman filter or the like.

The system may include a lane data processing module. This module may be responsible for processing raw data received from the fusion module. The lane data processing module may transform the fusion data into a form that is more easily used by downstream components of the driving assist system. The lane data processing module may generate next junction/intersection data (e.g., one or more Cartesian coordinates). For example, the lane data processing module may generate Cartesian coordinates that define the location (relative to the equipped vehicle) of an upcoming intersection.

Optionally, the system includes a vehicle state estimator module. This module includes control modules/algorithms that provide vehicle state information such as vehicle speed, yaw rate, vehicle gear, etc. A driver input processing module may be responsible for processing driver inputs such as human machine interface (HMI) inputs or actuations, button actuations, voice commands, gestures, accelerator/brake pedal actuation, steering wheel actuation, etc.

A threat assessment module evaluates at least a portion of objects in the near vicinity of the vehicle to assess the threat potential for each of the objects. For example, the threat assessment module assesses a threat level for each object (e.g., target vehicles) within a threshold distance in front of the vehicle (e.g., within at least 10 m from the front of the equipped vehicle, within at least 30 m from the front of the equipped vehicle, within at least 50 m from the front of the equipped vehicle, etc.). The threat assessment module may be lane-based and may supplement a nominal threat assessment algorithm by enforcing lane dependency, if present, on potential threats to minimize false detections. When the sensors (e.g., cameras and/or radar sensors) provide road junction information (e.g., position of junction/intersection points on the route ahead of the equipped vehicle), the threat assessment module may utilize additional threat assessment logic for efficient braking that allows the equipped vehicle to stop just before crossing the junction. For example, based on the vehicle's current position and the distance between the vehicle and the intersection/junction, the system may determine an optimal braking command that halts the vehicle just prior to the intersection.

The system may include a closed-loop AEB longitudinal controller that is responsible for applying an optimal level of safety braking to prevent imminent collision within limits and to achieve consistent stopping distance. The system may apply brake assist in some specific situations. For example, in situations where the driver has initiated brake actuation in reaction to collision alerts with insufficient force (i.e., is not braking fast enough to stop a collision), the brake assist sub-function may provide the necessary remaining brake torque to avoid collision through the brake assist function. In another example, the system may apply prefill when a hard braking event is anticipated. Brake prefill helps increase the hydraulic pressure in the brake lines to quicken the response time of the brakes and shorten stopping distances. In yet another example, when the system (via, for example, the AEB controller or vehicle brake module) brings the equipped vehicle to a stop, the system may hold the brake command for additional time to allow the driver time to assess the situation and take over (i.e., perform a takeover maneuver). The driver may override the brake hold stage/perform the takeover maneuver at any time via steering, braking, throttle overrides, etc.

The threat evaluation module may track the equipped vehicle's current or predicted trajectory along with a predicted trajectory for at least a portion of the detected objects (e.g., based on the previously traveled path of the equipped vehicle/detected object) and/or predict the future path using different attributes such as relative distances, velocity, yaw rate, heading, etc. The threat evaluation module may calculate an intersection/collision point based on the predicted paths of the equipped vehicle and detected objects/target vehicles. The threat evaluation module may determine or calculate a time to collision (TTC) between the equipped vehicle and one or more of the detected objects. The threat level of each detected object may be based on the respective TTC for each object. For example, the threat evaluation module may determine the object is a threat when the TTC is less than a threshold amount of time (e.g., less than ten seconds, less than five seconds, less than 3 seconds, less than 1 second, etc.). The threat evaluation module may sort or rank threats based at least partially on the TTC (e.g., a lower TTC results in a higher threat rank). The threat evaluation module may include different hysteresis to confirm the threat presence and to avoid any switching of targets and switching of alerts. For example, the threat evaluation module may use time-based hysteresis to enable or disable delays for threat selection. In another example, the threat evaluation module uses distance-based hysteresis to generate an adaptable bounding box wherein boundaries are defined for a target to threat classification. The bounding box attributes may be dependent on the distance between the equipped vehicle and the predicted collision point. The module may confirm threats out of all the potential threats using some predefined metrics based on the target TTC, target attributes, and/or the deceleration of the equipped vehicle required to achieve collision avoidance.

A warning controller may be responsible for alerting the driver or other occupant of the vehicle via audible, visual, and/or haptic feedback when the threat assessment module determines an object is a sufficient threat (e.g., the threat level meets or exceeds a threat threshold value). The threat threshold value may be based on a likelihood of collision between the equipped vehicle and a detected object and/or a severity of a collision if the collision were to occur. The warning controller may sound an alarm, flash lights, vibrate the steering wheel/seat, display a warning on one or more displays within the vehicle, etc. Optionally, a human-machine interface (HMI) module receives the warnings/notifications from the warning controller and presents the warnings to the driver or other occupants of the vehicle. Optionally, the system includes a vehicle brake module that includes or is in communication with the braking system (e.g., hardware and/or software) of the vehicle. The vehicle brake module generates braking torque command to enable ADAS feature for longitudinal control (e.g., increasing or decreasing vehicle velocity/acceleration). A haptic controller module may alert the driver through a series of braking events that do not materially or significantly cause vehicle deceleration, but instead provide haptic feedback to the occupants of the vehicle via rapid changes in acceleration of the equipped vehicle.

The system, using the modules illustrated in the block diagram 30, may generate braking deceleration commands based on fusion signals that combine sensor data captured by both a camera and a radar sensor. An object data processing module/threat filtering module may filter the object data (e.g., derived from the fusion data) for disturbances and predict a position for each detected object using, for example, relevant object signals when new data is not available from the sensor system. That is, if the object is temporarily “lost” in the sensor data (e.g., the object moves behind an obstruction, the sensors experience temporary loss of function, etc., and the object can no longer be detected via the sensor data), the object data processing module may predict the current location of the object based on past data (e.g., position, velocity, acceleration, heading, etc.). The module may include an object rejection filter that rejects objects which appear for less than a threshold period of time and/or an object filter that applies logic reasoning to negate preceding/oncoming objects based on the overall object data received from sensors.

When multiple objects (e.g., at least ten objects or at least twenty objects) are detected based on sensor data captured by the camera(s) and/or the radar sensor(s), the object data processing module may select a subset of the detected objects (e.g., a configurable amount, such as three to five objects) that are the most relevant objects (i.e., most likely to be a threat or most likely to collide with the equipped vehicle). The selection may be done based on a number of factors. For example, the selection may be based on whether the object is moving/stationary, velocity, acceleration, heading, trajectory, position relative to the equipped vehicle (e.g., in front or behind the equipped vehicle), size, estimated mass, etc.

As shown in FIG. 1, the system may use a combination of cameras, corner radars sensors (e.g., disposed at the front bumper of the equipped vehicle), and other hardware/sensors to detect and react to cross-traffic situations. As shown, the fields of sensing of one or more sensors may at least partially overlap, providing redundancy and additional accuracy via sensor fusion. Additionally or alternatively, multiple sensors may provide a wider field of sensing than a single sensor can provide (such as at least 90 degrees in front of the vehicle, at least 120 degrees in front of the vehicle, 180 degrees in front of the vehicle, etc.).

The system may operate to assist a driver of the vehicle in avoiding a collision or may autonomously control the vehicle to avoid a collision. For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to other vehicles and objects at the intersection. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a camera disposed at a vehicle equipped with the vehicular driving assist system, the camera viewing at least forward of the vehicle and operable to capture image data;
a radar sensor disposed at the vehicle, the radar sensor sensing at least forward of the vehicle and operable to capture sensor data, wherein a field of sensing of the radar sensor at least partially overlaps a field of view of the camera;
an electronic control unit (ECU) comprising electronic circuitry and associated software;
wherein image data captured by the camera and sensor data captured by the radar sensor are transferred to and are processed at the ECU;
wherein the vehicular driving assist system, via processing at the ECU of image data captured by the camera and transferred to the ECU, determines lane markers of a road along which the vehicle is traveling;
wherein, with the vehicle approaching an intersection, the vehicular driving assist system, based at least in part on processing at the ECU of (i) image data captured by the camera and transferred to the ECU and (ii) sensor data captured by the radar sensor and transferred to the ECU, determines that an object is traveling along a traffic lane that intersects with a traffic lane the vehicle is traveling along;
wherein the vehicular driving assist system, responsive to determining that the object is traveling along the traffic lane that intersects with the traffic lane the vehicle is traveling along, determines a time to collision (TTC) between the vehicle and the object at the intersection; and
wherein the vehicular driving assist system, responsive at least in part to determining the TTC between the vehicle and the object at the intersection is below a threshold amount of time, generates a braking command to slow the vehicle prior to the vehicle reaching the intersection.

2. The vehicular driving assist system of claim 1, wherein the vehicular driving assist system determines the TTC based on a predicted trajectory of the object and a predicted trajectory of the vehicle.

3. The vehicular driving assist system of claim 1, wherein the vehicular driving assist system determines the TTC between the vehicle and the object at the intersection after the vehicular driving assist system repeatedly detects the object for at least a threshold period of time.

4. The vehicular driving assist system of claim 1, wherein the vehicular driving assist system, prior to determining the TTC between the vehicle and the object at the intersection, determines the object is a threat, and wherein the vehicular driving assist system determines the object is a threat based at least in part on (i) time-based hysteresis and (ii) distance-based hysteresis.

5. The vehicular driving assist system of claim 1, wherein the vehicular driving assist system determines a plurality of objects traveling along respective traffic lanes that intersect with the traffic lane the vehicle is traveling along, and wherein the vehicular driving assist system selects a subset of the plurality of objects based on a likelihood of collision of each object of the plurality of objects with the vehicle.

6. The vehicular driving assist system of claim 5, wherein the vehicular driving assist system determines the TTC between the vehicle and each object of the subset of objects.

7. The vehicular driving assist system of claim 5, wherein the vehicular driving assist system determines the likelihood of collision with each respective object of the plurality of objects based on at least one selected from the group consisting of (i) a velocity of the respective object, (ii) a trajectory of the respective object and (iii) a location of the respective object relative to the vehicle.

8. The vehicular driving assist system of claim 1, wherein the braking command slows the vehicle to a stop prior to the vehicle entering the intersection.

9. The vehicular driving assist system of claim 8, wherein the vehicular driving assist system, after braking the vehicle to a stop, keeps the vehicle stopped until a driver of the vehicle performs a takeover maneuver.

10. The vehicular driving assist system of claim 9, wherein the takeover maneuver comprises at least one selected from the group consisting of (i) actuating a brake pedal and (ii) actuating an acceleration pedal.

11. The vehicular driving assist system of claim 1, wherein the vehicular driving assist system fuses (i) image data captured by the camera and transferred to the ECU and (ii) sensor data captured by the radar sensor and transferred to the ECU, and wherein the fused image data and sensor data is processed at the ECU.

12. The vehicular driving assist system of claim 1, wherein the vehicular driving assist system determines the TTC based at least in part on a determined collision point between the object and the vehicle.

13. The vehicular driving assist system of claim 1, wherein the vehicular driving assist system, responsive to determining the TTC between the vehicle and the object at the intersection, generates an alert for a driver of the vehicle.

14. The vehicular driving assist system of claim 13, wherein the alert comprises a haptic alert, and wherein the vehicular driving assist system generates the haptic alert based on intermittent braking of the vehicle.

15. A vehicular driving assist system, the vehicular driving assist system comprising:
a camera disposed at a vehicle equipped with the vehicular driving assist system, the camera viewing at least forward of the equipped vehicle and operable to capture image data;
a radar sensor disposed at the equipped vehicle, the radar sensor sensing at least forward of the equipped vehicle and operable to capture sensor data, wherein a field of sensing of the radar sensor at least partially overlaps a field of view of the camera;
an electronic control unit (ECU) comprising electronic circuitry and associated software;
wherein image data captured by the camera and sensor data captured by the radar sensor are transferred to and are processed at the ECU;
wherein the vehicular driving assist system, via processing at the ECU of image data captured by the camera and transferred to the ECU, determines lane markers of a road along which the equipped vehicle is traveling;
wherein, with the equipped vehicle approaching an intersection, the vehicular driving assist system, based at least in part on processing at the ECU of (i) image data captured by the camera and transferred to the ECU and (ii) sensor data captured by the radar sensor and transferred to the ECU, determines that a plurality of other vehicles are traveling along a road that intersects with a traffic lane the equipped vehicle is traveling along;
wherein the vehicular driving assist system, responsive to determining that the plurality of other vehicles are traveling along the road that intersects with the traffic lane the equipped vehicle is traveling along, determines, for each respective other vehicle of the plurality of other vehicles, a time to collision (TTC) between the equipped vehicle and the respective other vehicle at the intersection;
wherein the vehicular driving assist system determines, based at least in part on the determined TTC, a respective threat level for each respective other vehicle of the plurality of other vehicles;
wherein the vehicular driving assist system, determines that a threat level for at least one of the plurality of other vehicles exceeds a threshold threat level; and
wherein the vehicular driving assist system, responsive to determining that the threat level for the at least one of the plurality of other vehicles exceeds the threshold threat level, generates a warning for an occupant of the equipped vehicle.

16. The vehicular driving assist system of claim 15, wherein the vehicular driving assist system, responsive at least in part to determining that the threat level for the at least one of the plurality of other vehicles exceeds the threshold threat level, generates a braking command to slow the equipped vehicle prior to the equipped vehicle reaching the intersection.

17. The vehicular driving assist system of claim 15, wherein the vehicular driving assist system determines each TTC based on a predicted trajectory of the respective other vehicle and a predicted trajectory of the equipped vehicle.

18. The vehicular driving assist system of claim 15, wherein the vehicular driving assist system determines each TTC between the equipped vehicle and the respective other vehicle at the intersection after the vehicular driving assist system repeatedly detects the respective other vehicle for at least a threshold period of time.

19. The vehicular driving assist system of claim 15, wherein the vehicular driving assist system determines each respective threat level based at least in part on (i) time-based hysteresis and (ii) distance-based hysteresis.

20. A vehicular driving assist system, the vehicular driving assist system comprising:
a camera disposed at a vehicle equipped with the vehicular driving assist system, the camera viewing at least forward of the equipped vehicle and operable to capture image data;
a radar sensor disposed at the equipped vehicle, the radar sensor sensing at least forward of the equipped vehicle and operable to capture sensor data, wherein a field of sensing of the radar sensor at least partially overlaps a field of view of the camera;
an electronic control unit (ECU) comprising electronic circuitry and associated software;
wherein image data captured by the camera and sensor data captured by the radar sensor are transferred to and are processed at the ECU;
wherein the vehicular driving assist system, via processing at the ECU of image data captured by the camera and transferred to the ECU, determines lane markers of a road along which the equipped vehicle is traveling;
wherein, with the equipped vehicle approaching an intersection, the vehicular driving assist system, based at least in part on processing at the ECU of (i) image data captured by the camera and transferred to the ECU and (ii) sensor data captured by the radar sensor and transferred to the ECU, determines that another vehicle is traveling along a road that intersects with a traffic lane the equipped vehicle is traveling along;
wherein the vehicular driving assist system, responsive to determining that the other vehicle is traveling along the road that intersects with the traffic lane the equipped vehicle is traveling along, determines a time to collision (TTC) between the equipped vehicle and the other vehicle at the intersection based on a predicted trajectory of the other vehicle and a predicted trajectory of the equipped vehicle;
wherein the vehicular driving assist system, responsive to determining the TTC between the equipped vehicle and the other vehicle at the intersection is below a threshold amount of time, generates a braking command to slow the equipped vehicle to a stop prior to the equipped vehicle reaching the intersection; and
wherein the vehicular driving assist system, after braking the equipped vehicle to a stop, keeps the equipped vehicle stopped until a driver of the equipped vehicle performs a takeover maneuver.

21. The vehicular driving assist system of claim 20, wherein the takeover maneuver comprises at least one selected from the group consisting of (i) actuating a brake pedal and (ii) actuating an acceleration pedal.

22. The vehicular driving assist system of claim 20, wherein the vehicular driving assist system fuses (i) image data captured by the camera and transferred to the ECU and (ii) sensor data captured by the radar sensor and transferred to the ECU, and wherein the fused image data and sensor data is processed at the ECU.

23. The vehicular driving assist system of claim 20, wherein the vehicular driving assist system determines the TTC based at least in part on a determined collision point between the other vehicle and the equipped vehicle.
